(19) United States
(12) Patent Application Publication
(10) Pub. No.: US 2009/0155543 A1
(43) Pub. Date: Jun. 18, 2009

(54) INSULATING MATERIALS AND METHODS OF MAKING THE SAME

(76) Inventor: Rick Fowler, Seattle, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/176,260

(22) Filed: Jul. 18, 2008

Related U.S. Application Data
(60) Provisional application No. 60/961,151, filed on Jul. 18, 2007.

(51) Int. Cl. B32B 3/00; B32B 37/14

(52) U.S. Cl. 428/179; 156/290

(57) ABSTRACT

Insulating materials and methods for making the same are shown and described. The insulating material may include a first layer, a second layer, and a plurality of baffles between and coupled to the first and second layers. The baffles can be evenly or unevenly spaced from one another such that a substantial portion of the first layer is spaced apart from the second layer when the multilayer material forms clothing worn by a user.

### CROSS-REFERENCE TO RELATED APPLICATION

This application claims the benefit under 35 U.S.C. § 119(e) of U.S. Provisional Patent Application No. 60/961,151 filed Jul. 18, 2007, which is incorporated herein by reference in its entirety.

### BACKGROUND

1. Technical Field

The present disclosure generally relates to insulating materials and methods of making the same, and more specifically to multilayer materials.

2. Description of the Related Art

Multilayer thermal insulation is often used to form articles, such as clothing. These materials can include an insulator, such as batting, sandwiched between two sheets of fabric. If the insulator is sewn directly to the fabric, the stitching process can result in the formation of permanent needle holes through the sheets. Stitching can pass through these needle holes to limit movement of the insulator relative to the sheets. The needle holes may compromise the integrity of the sheets by, for example, serving as initiation sites for tears, thereby appreciably reducing the tear strength of the sheets.

If a portion of the insulator passes through the sheets via the needle holes, the visible insulating material results in an unsightly appearance. Additionally, the needle holes may allow unwanted contaminates, such as water or particles (e.g., dirt, dust, etc.), to enter the region between the sheets. Air passing through the needle holes can appreciably reduce thermal performance and wind barrier characteristics of the multilayer material. If significant amounts of ambient air pass through the fabric sheets, the multilayer material may not function as an effective thermal barrier. Accordingly, applying stitches to multilayer materials may reduce performance and lead to different types of problems, thereby rendering the multilayer material unsuitable for many applications.

Multilayer thermal insulation often has a relatively low peel strength and may not be capable of withstanding forces that are frequently produced during normal use. If a multilayer material with low peel strengths forms an outer shell and a lining of a jacket, the layers of the multilayer material may peel apart resulting in the formation of unwanted movement of internal insulating material, irregular surface contours of the shell, and the like. For example, a wearer's normal body movement may subject the jacket to a wide range of different forces that cause separation at various interfaces. Conventional multilayer insulating sheets, for example, often have a discrete layer coupled to a fabric via a direct glue bond that has a relatively low peel strength rendering these materials prone to separation when pulling forces perpendicular to the sheets are applied.

### BRIEF SUMMARY

Some embodiments disclosed herein are multilayer materials having improved properties, such as improved tear strength, repellency (e.g., water repellency), peel resistance, insulating properties, and the like. Chemicals applied to multilayer materials may improve tear strength, water repellency, flexibility, and the like. Some embodiments disclosed herein include multilayer insulating sheets configured to minimize or limit forces, such as normal forces, applied to interfaces between components of the sheets. The sheets have internal baffles that minimize or limit movement of insulating material within the sheet. The shape and configuration of the baffles may inherently minimize or limit stresses, such as at the interfaces. In some embodiments, the baffles are adapted to minimize or reduce interfacial peel stresses.

Baffles can be used to form compartments, channels, chambers, or other structures for holding insulating materials. The baffles can be arranged in different configurations and patterns. In some embodiments, the baffles form sidewalls or partitions that divide the space between two layers into isolated chambers. The two layers can be securely held together by the baffles. Adhesive interfaces along the chamber walls enable bonded or glued constructions capable of resisting different types of stresses.

The multilayer materials can include one or more supporting films. The supporting films can be positioned at interfaces between baffles and the outer layers. A supporting film can provide a relatively large surface area for adhesively coupling to a wide range of materials. In some embodiments, peel forces can reach the film made of a tough material (e.g., a polymer, fabric, or the like) that spreads the load, thereby avoiding excessive or premature loading and failure of, for example, a coating or film on the adjacent layer or substrate. Exemplary supporting films can be a single layer or a plurality of layers and can be made, in whole or in part, of polyether polyurethane or other suitable materials. Various glues, co-polyester hot melt adhesives, polyamides, or other types of adhesives can couple the supporting film to the baffle of outer layer.

The supporting films can extend outwardly beyond the baffles. For example, the supporting film can have a surface area that is substantially greater than the surface area of the contact region of the baffle. The baffle can be coupled to a region (e.g., a central region) of the supporting film such that the supporting film extends outwardly beyond the periphery of the baffle. Flanges of the baffle can define wings or tabs suitable for transferring loads to the supporting film.

The multilayer constructions, in some embodiments, provide a wide range of insulating capabilities to minimize, limit, or substantially prevent the transfer of an appreciable amount of energy therethrough. The energy may be thermal energy, acoustic energy, or other types of energy.

In some embodiments, a multilayer construction includes a first layer, a second layer, and a plurality of baffles between and coupled to the first and second layers. Insulating material is located between the first and second layers. The baffles are evenly or unevenly spaced from one another. Each baffle maintains or limits separation between the first and second layers while also helping to prevent unwanted movement of the insulating material.

In some embodiments, a method of manufacturing of a flexible multilayer material is provided. The method comprises coupling a plurality of baffles to and between a first sheet of fabric and a second sheet of fabric. Insulation is placed between the first and second sheets. The baffles and insulation cooperate to maintain a desired amount of separation of the first and second sheets. The insulation functions as a barrier to heat transfer therethrough.

In some other embodiments, a multilayer construction includes one or more baffles used to couple two layers together. The baffles minimize, limit, or substantially prevent peeling between components of the multilayer construction. The multilayer construction, for example, is capable of withstanding forces, such as relatively high forces, to minimize, limit, or substantially prevent separation (e.g., delamination). The shape and configuration of the baffles can change during use to reduce or limit stress that may cause interlaminar separation between the baffles and the layers. Supporting films can further inhibit peeling or other modes of failure.

In some embodiments, a multilayer fabric sheet includes a first layer of fabric, a second layer of fabric, insulation positioned between the first and second layers of fabric, and a plurality of baffles between the first and second layers of fabric. Each baffle includes an upper member, a lower member, and a central member. The upper member lays along and is stitchlessly coupled to the first layer of fabric. The lower member lays along and is coupled to the second layer of fabric. The central member has an upper end physically coupled to the upper member and a lower end physically coupled to the lower member. The upper end is spaced apart from opposing terminal edges (e.g., edges at free ends) of the upper member. The lower end is spaced apart from the opposing terminal edges of the lower member.

A peel resistance at the interface between at least one of the baffles and the first layer of fabric is equal to or greater than about 10 lb_{f}/inch, as measured according to ASTMD-715-98. In other embodiments, the peel resistance at the interface is equal to or greater than 10 lb_{f}/inch, 30 lb_{f}/inch, and the like. The peel resistance can be increased or decreased based on the application of the sheet. In some embodiments, the baffle is coupled directly to the second layer of fabric via a bonding process. In other embodiments, the lower member is indirectly coupled to the second layer of fabric by an intermediate adhesive layer.

In some embodiments, a multilayer material for making an article of clothing comprises a first layer of fabric, a second layer of fabric, an insulating material, and a plurality of baffles. The insulating material is between the first layer and the second layer. The plurality of elongate baffles stitchlessly couples the first layer of fabric to the second layer of fabric. Each of the baffles has a pair of outwardly extending flanges coupled to the first layer of fabric.

In some other embodiments, a method of manufacturing is provided. The method of manufacturing includes stitchlessly coupling an upper member of an internal baffle to an upper layer of fabric. The internal baffle includes a lower member and a central member having an upper end coupled to the upper member and a lower end coupled to the lower member. The upper end is spaced apart from opposing free ends of the upper member. The lower end is spaced apart from opposing free ends of the lower member. The method, in some embodiments, further includes coupling the lower member to the lower layer of fabric. Insulation is positioned between the upper layer of fabric and the lower layer of fabric. In some embodiments, the insulation is positioned before coupling the upper member to the upper layer. In other embodiments, the insulation is positioned after coupling the upper member to the upper layer and coupling the lower member to the lower layer. One or more supporting films can be positioned between the baffles and one or both of the first and second layers.

In yet other embodiments, a method of manufacturing a multilayer material comprises providing a first layer of fabric and a second layer of fabric. A plurality of longitudinally-extending baffles is stitchlessly coupled to the first layer of fabric such that each of the baffles has an outwardly extending flange lying along and coupled to the first layer of fabric. The plurality of baffles is coupled to the second layer of fabric, and insulation is positioned between the first layer of fabric and the second layer of fabric.

In further embodiments, a method of manufacturing a multilayer material is provided. The method comprises stitchlessly coupling a plurality of first baffles to a lower surface of a first textile layer such that each of the first baffles has a first web portion extending away from the lower surface. A plurality of second baffles is coupled to an upper surface of a second textile layer such that each of the second baffles has a second web portion extending away from the upper surface. The first web portions are coupled to corresponding second web portions such that the first textile layer is coupled to the second textile layer. In some embodiments, the first baffles and second baffles cooperate to form baffle assemblies having substantially I-shaped transverse cross-sectional profiles, substantially H-shaped transverse cross-sectional profiles, or substantially C-shaped cross-sectional profiles. The web portions can be generally straight, J-shaped, T-shaped, L-shaped, and the like. The baffle assemblies can be made of polymers, plastics, rubbers, fabrics, textiles, and the like.

In some embodiments, a baffle has an upper surface for coupling to an upper layer and a lower surface for coupling to a lower layer. The baffle can extend continuously and uninterruptedly between the upper and lower surfaces to reduce, limit, or substantially prevent failures associated with the baffle separating. In some embodiments, the baffle has upper flanges and lower flanges that are interconnected by a central member (e.g., a web) that extends continuously therebetween. The baffle can be monolithically formed through a molding process, extrusion process, and the like.

### BRIEF DESCRIPTION OF THE SEVERAL VIEWS OF THE DRAWINGS

FIG. 1 is an elevational view of an article of clothing made of an insulating material, in accordance with one illustrated embodiment.

FIG. 2 is an isometric view of a multilayer material, in accordance with one illustrated embodiment.

FIG. 3 is a side elevational view of a multilayer material, in accordance with one illustrated embodiment. Insulation is shown removed.

FIG. 4 is a detailed, partial cross-sectional view of a portion of the multilayer material of FIG. 3.

FIG. 5 is a side elevational view of a multilayer material moved from a first configuration to a second configuration.

FIGS. 6-9 show multilayer materials having baffles between a pair of spaced apart layers, in accordance with one illustrated embodiment.

FIG. 10 is a side elevational view of a baffle assembly, in accordance with one illustrated embodiment.

FIG. 11 is a side elevational view of the baffle assembly of FIG. 10 coupled to a pair of spaced apart layers, in accordance with one illustrated embodiment.

FIG. 12 is a pictorial view of a multilayer material, in accordance with one illustrated embodiment.

FIG. 13 is a cross-sectional view of a multilayer material having a pair of baffles coupled together, in accordance with one illustrated embodiment.

FIG. 14 is a cross-sectional view of a multilayer material having a pair of baffles adhesively coupled together, in accordance with one illustrated embodiment.

FIG. 15A is a cross-sectional view of a multilayer material having a baffle stitchlessly coupled to an upper layer, in accordance with one illustrated embodiment.

FIG. 15B is a cross-sectional view of a multilayer material having a baffle stitchlessly coupled to an upper layer, in accordance with one illustrated embodiment.

FIG. 16 is a cross-sectional view of a multilayer material having a pair of nested baffles, in accordance with one illustrated embodiment.

FIGS. 17-20 show one method of manufacturing a multilayer material.

FIG. 21 is an elevational view of a multilayer material having side-by-side baffles coupled together, in accordance with one illustrated embodiment.

FIGS. 22-26 are cross-sectional elevational views of various multi-layer constructions.

### DETAILED DESCRIPTION

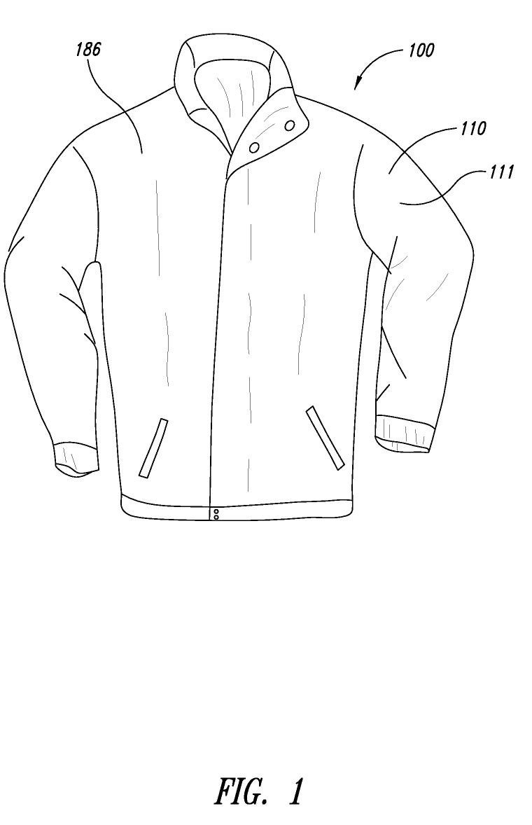

Embodiments disclosed herein are generally directed towards textiles and products made of textiles suitable for a wide range of applications. The textile products can be used to make garments (e.g., pants, shorts, jackets, shirts, vests, or the like), bedding (e.g., blankets, sheets, sleeping bags, comforters, or the like), outdoor gear (e.g., camping gear), or panels (e.g., insulating panels, acoustic panels, or the like), as well as building materials. Portions of the textile products can be made without using stitching to reduce, limit, or substantially prevent migration of substances (e.g., water, contaminates, or air) through needle holes for enhanced insulating properties. Many specific details of certain embodiments are set forth in the following description and are illustrated in FIGS. 1-26 to provide a thorough understanding of such embodiments. One skilled in the art, however, will understand that the embodiments may have additional features or components, or may be practiced without several of the details described in the following description.

FIG. 1 shows an article of clothing 100 (illustrated as a garment in the form of a jacket) made of a multilayer material 110. The material 110 can provide a wide range of insulating capabilities to minimize, limit, or substantially prevent the passage of an appreciable amount of thermal energy therethrough. The jacket 100 can be worn in extreme environments, such as extremely cold weather, to help maintain proper body temperature of the wearer.

Various portions of an exterior surface 111 of the jacket 100 may be devoid of any stitching and associated stitching holes for improved liquid-impermeability, gas-impermeability, reduction or elimination of exposed unsightly insulation material (e.g., insulation material that escapes through the holes), and/or the like. The exterior surface 111 can thus minimize, limit, or substantially prevent a wide range of unwanted contaminates from passing through the material 110. Internal baffles can define compartments with chambers that help keep fillers, such as thermal insulation materials, properly distributed for desired thermal characteristics.

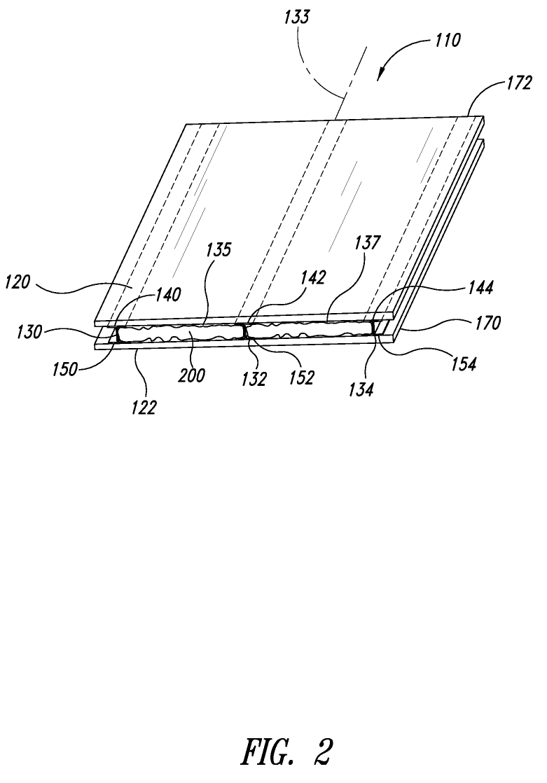

FIG. 2 shows the material 110 including a first layer 120 and a second layer 122 coupled to the first layer 120 by a plurality of internal baffles 130, 132, 134. The baffles 130, 132, 134 include respective upper members 140, 142, 144 stitchlessly coupled to the first layer 120 and respective lower members 150, 152, 154 stitchlessly coupled to the second layer 122. The baffles 130, 132, 134 are spaced from one another and extend continuously and uninterruptedly between opposing sides 170, 172 of the material 110. Embedded portions of the baffles 130, 132, 134 are shown in phantom line.

The first and second layers 120, 122 can be made, in whole or in part, of one or more textiles (e.g., cloths or goods produced by weaving, knitting, and/or felting), fabrics (e.g., non-woven fabrics, woven fabrics, or the like), permeable materials (e.g., liquid and/or vapor permeable materials), semi-permeable materials, impermeable materials (e.g., waterproof materials), and the like. The first and second layers 120, 122 can be made of natural fibers (e.g., cotton, silk, wool, or the like), synthetic fibers (e.g., polymers such as polyester), and combinations thereof. In some embodiments, each of the first and second layers 120, 122 include one or more sheets, such as sheets of fabric.

The illustrated first layer 120 can define the outermost surface 111 (e.g., the shell) of the jacket 100 (see FIG. 1) and can be made of a resistant material, such as polyester. The second layer 122 can form an interior layer of the jacket 100 and can be made, in whole or in part, of cotton, or other permeable or semi-permeable material. For example, the second layer 122 can be a breathable lining comprised of a single layer or a plurality of layers.

Insulation 200 of FIG. 2 is sandwiched between the first and second layers 120, 122 and can be made, in whole or in part, of down (e.g., goose down), batting, filler, fibrous insulation, high-loft insulation, combinations thereof, or the like. The insulation 200 can be, for example, loosely packed natural or synthetic fibers and may help maintain separation of the first and second layers 120, 122, even when the jacket 100 is moved during normal use, thereby functioning as an effective thermal barrier. The average distance between the first and second layers 120, 122, type and amount of insulation 200, and placement of the baffles 130, 132, 134 can be selected to provide the desired insulating properties.

With continued reference to FIG. 2, the multilayer material 110 can have enhanced mechanical properties as compared to conventional multilayer materials. In some embodiments, the material 110 has a peel strength equal to or greater than about 10 lb_{f}/inch, as measured according to ASTM D-751-98, 2-inch strip modified grab method or ASTM D902. Various types of similar testing techniques and procedures can be used to determine the average or local peel strength of the material 110. In some embodiments, the material 110 can have a peel strength that is equal to or greater than 30 lb_{f}/inch, 50 lb_{f}/inch, 70 lb_{f}/inch, or 80 lb_{f}/inch, or ranges encompassing such strengths. The baffles 130, 132, 134 can deform to control (e.g., reduce or limit) interfacial stresses, such as the peel stress, when forces are applied to the material 110. If the material 110 is subjected to significant pulling forces normal to the material 110, the peel strength can be equal to or greater than about 70 lb_{f}/inch. Other peel strengths are also possible. Adhesion characteristics can be evaluated in accordance with ASTM D903 and/or ASTM D3807. Because the baffles 130, 132, 134 are adapted to accommodate different types of loading to reduce stresses, both low strength and high strength adhesives can be incorporated into the material 110.

The baffles 130, 132, 134 can help maintain the desired spatial relationship between the first and second layers 120, 122 while limiting migration of the insulation 200. For example, the baffles 130, 132, 134 can limit separation of the first and second layers 120, 122, thereby allowing the multilayer insulating material 110 to be filled with significant amounts of insulation 200. The insulation 200 may cause the first and second layers to bulge outwardly. In some embodiments, the baffles 130, 132, 134 are configured to maintain an average distance between the first and second layers 120, 122 that is less than, for example, about, 0.2 inch, 0.5 inch, or 0.75 inch, or about 1 inch. In some embodiments, the baffles 130, 132, 134 are configured to maintain an average distance between the first and second layers 120, 122 that is in the range of about 0.1 cm to about 8 cm or in a range of about 0.5 cm to about 8 cm

The baffles 130, 132, 134 can be generally similar to each other and, accordingly, the following description of one of the baffles applies equally to the others, unless indicated otherwise. As used herein, the term “baffle” is broadly construed to include, without limitation, one or more spacers, ribs, partitions, walls, or other types of one-piece or multi-piece members capable of coupling together two or more layers. The baffle 130 can function as a physical barrier to reduce, limit, or substantially prevent unwanted movement of the insulation 200, as well as to inhibit or substantially prevent movement of other substances (e.g., contaminates), gases (e.g., air) liquids (e.g., water), or the like.

With continued reference to FIG. 2, the baffles 130, 132 and the first and second layers 120, 122 can form, at least in part, an isolation chamber 135 for containing the insulation 200. The illustrated chamber 135 is generally rectangular. The baffle 132 defines a sidewall and maintains separation between the isolation chamber 135 and an adjacent isolation chamber 137. The baffle 132, in some embodiments, prevents an appreciable amount of insulation from traveling between the isolation chambers 135, 137. In some embodiments, less than about 3% by weight of the insulation 200 in the chamber 135 moves past the baffle 132 after a jacket 100 made of the material 110 is worn for about 100 hours. The baffles can thus be used to keep the insulation 200 unevenly or evenly distributed throughout the material 110 as desired.

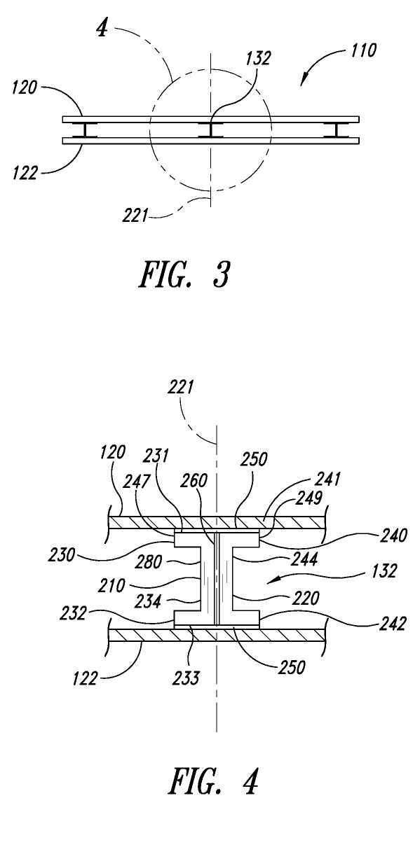

Referring to FIGS. 3 and 4, the multi-piece baffle 132 has a substantially I-shaped transverse cross-section and includes first and second members 210, 220 positioned next to one another. Each of the first and second members 210, 220 has a one-piece construction and can also have a generally U-shaped cross-section, C-shaped cross-section, J-shaped cross-section, or any other suitable cross-section to achieve the desired performance. The cross-sections can be taken approximately perpendicular to a longitudinal axis 133 (FIG. 2) of the longitudinally-extending baffle 132. The baffle 132 can also be approximately symmetrical with respect to a central plane 221.

The first member 210 of FIG. 4 has an upper portion 230, a lower portion 232, and a central member 234, illustrated as a web, extending between the upper and lower portions 230, 232. The height defined between an outer surface 231 of the upper portion 230 and an outer surface 233 of the lower portion 232 is in a range of about 0.1 inch to about 0.5 inch, such that the first member 210 is well suited for use in jackets, or other articles of clothing. In some embodiments, the height of the first member 210 is in a range of about 0.1 inch to about 1.5 inches, such that the first member 210 is suitable to make sleeping bags or other sleeping products that have significant amounts of insulation. Other dimensions are also possible.

The second member 220 can be substantially similar to the first member 210 and includes an upper portion 240, a lower portion 242, and a central member 244 extending between the upper and lower portions 240, 242. The central member 244 is coupled directly to the central member 234.

The upper portions 230, 240 can be flexible flanges that lay along and are fixedly coupled to (either directly or indirectly) the first layer 120. Free ends 247, 249 are spaced apart from the central sections 234, 244. The lower portions 232, 242 can be flexible flanges that lay along and are fixedly coupled to the second layer 122. The illustrated flanges 230, 232, 240, 242 can be generally flat strips movable with respect to the central members 234, 244. For example, the flange 230 can be a strip of fabric freely moved relative to the central member 234. When the jacket 100 is worn, the flanges 230, 232, 240, 242 can be sufficiently flexible to conform closely to wearer's body for a close fit, if needed or desired.

Various types of coupling techniques can be employed to permanently or temporarily couple the first and second layers 120,122 to the baffle 132. For example, adhesive 250, illustrated as a layer of an adhesive material, can stitchlessly couple the upper flanges 230, 240 to the first layer 120. The portion 241 of the layer 120 contacting the adhesive 250 is substantially devoid of any stitching holes. Thus, the layer 120 has superior properties as compared to conventional stitched materials. By way of example, the layer 120 is less permeable to air or water and/or may have a greater insulating capability than conventional stitched materials. The layer 120 can be an effective barrier against different types of substances, such as dirt or sand. Of course, stitching can be placed at other locations along the material 110 to make the jacket 100 or other article.

Adhesives include, but are not limited to, adhesives that may undergo a chemical reaction (e.g., cyanoacrylate), curable adhesives (e.g., acrylics), thermal adhesives (e.g., hot melts), flexible adhesives (e.g., silicone), epoxy, polyurethanes, polyesters, polyamides, bonding agents, glues, combinations thereof, and other types of substances suitable for coupling together two or more features. An adhesive can be a liquid, solid (e.g., a powder), gel, weld, or the like. For example, the adhesive 250 of FIG. 4 may be a glue that is applied as a liquid and that subsequently hardens to form a layer. This layer 250 permanently couples the flanges 230, 240 to the layer 120. In some embodiments, the first and second layers 120, 122 are coupled to the baffle 132 via a weld, such as a weld formed by ultrasonic welding or thermal welding. In some embodiments, including the illustrated embodiment of FIG. 4, an adhesive 260 in the form of a weld couples together the central members 234, 244 and can help increase or decrease the stiffness of a web 280 of the baffle 132. Various types of bonding or welding processes can be utilized based on the properties of the various components.

The baffle 132 can be made, in whole or in part, of one or more polymers, plastics, woven materials, knitted materials (e.g., knitted textiles), and/or rubbers (e.g., open-cell foam, closed-cell foam, and the like), and can be molded, cut, extruded, or stamped. The baffle 132 can be somewhat flexible to help reduce the likelihood of damage, such as tearing, of one or both first and second layers 120, 122. When the material 110 is compressed, the baffle 132 may help maintain at least some separation between the first and second layers 120, 122. For example, the web 280 may be made of a rigid material (e.g., polyurethane, polyester, combinations thereof, or the like) and may be able to withstand compressive loads without buckling. In some embodiments, the web 280 is adapted to withstand significant tensile loads. For example, each of the central sections 234, 244 may be made of a flexible material (e.g., a fabric strip) that limits separation of the first and second layers 120, 122 but allows the first layer 120 to move against the second layer 122.

Different manufacturing techniques can be used to make the material 110. One method of manufacturing includes stitchlessly coupling the upper flanges 230, 240 to the upper layer 120. The lower flanges 232, 242 are coupled to the lower layer 122. The flanges 230, 240, 232, 242 can be successively or simultaneously coupled to the corresponding layers 120, 122. The insulation 200 can be placed between the first and second layers 120, 122 before, during, and/or after installation of one or more of the baffles 130, 132, 134.

FIG. 5 shows the baffle 132 changing its configuration to minimize or limit the effects of tensile loads. The baffle 132 is movable between a substantially I-shaped configuration 270 (shown in phantom) and a substantially planar configuration 272. When a force is not applied to the material 110, the flanges 230, 240, 232, 242 can be substantially perpendicular to the web 280. The baffle 132 can be in the substantially planar configuration 272 to help reduce, limit, or substantially prevent separation of the first and second layers 120, 122 due to, for example, interfacial peel stress. The baffle 132 is adapted to keep the interfacial peel stress below the peel strength of the adhesive 250. When the first and second layers 120, 122 are pulled away from each other (indicated by the arrows 285, 287), most of the interfaces, such as the adhesive interfaces 250, may experience primarily shear stresses. The average peel stress at the illustrated adhesive 250 may be less than 50% of the average shear stress. Because the shear strength of the adhesive 250 is greater than its peel strength, the material 110 can withstand larger loads without interlaminar separation than conventional multilayer materials.

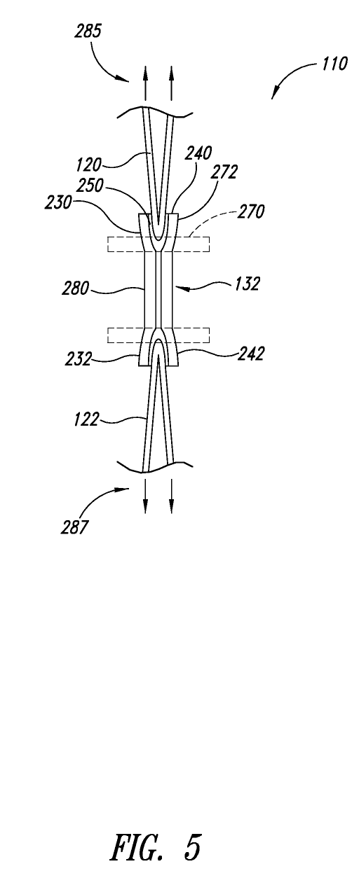

FIGS. 6-9 illustrate different types of one-piece baffles that can be used alone or in combination with one another. A baffle 280 of FIG. 6 includes upper and lower flanges 282, 284 coupled to first and second layers 290, 292, respectively. The upper flange 282 includes a pair of flaps 287, 289 extending outwardly from an upper end 297 of a unitary central member 300. The lower flange 284 includes a pair of flaps 298, 299 extending outwardly from a lower end 301 of the central member 300. The illustrated baffle 280 has a unitary one-piece construction.

The upper end 297 is positioned approximately midway between terminal edges 302, 303 (illustrated as free ends) of the flaps 287, 289. A distance from the upper end 297 and the nearest one of the terminal edges 302, 303 can be in a range of about 30% to about 70% of the width of the upper member 282 (i.e., the distance between the edges 302, 303).

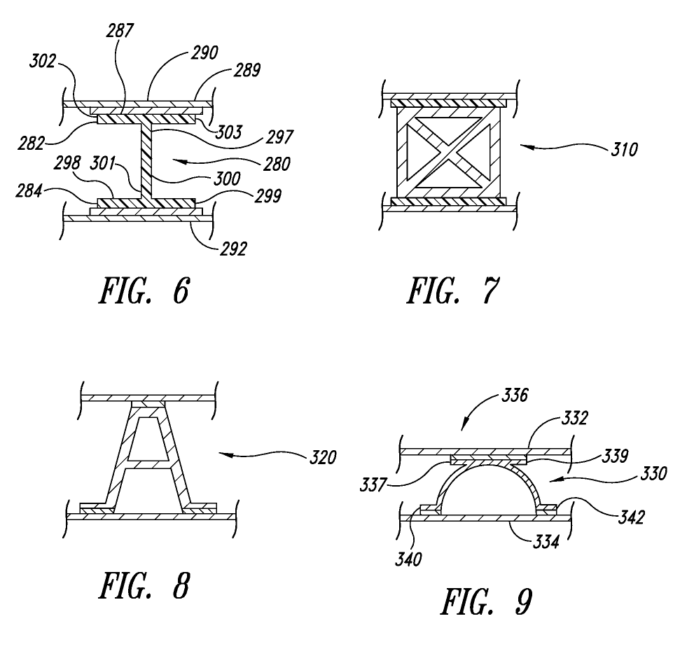

FIGS. 7 and 8 show baffles 310, 320, respectively, capable of withstanding relatively high compressive stresses without buckling in comparison to the baffle 280 of FIG. 6. These baffles can be adhered, stitched, combinations thereof, or otherwise coupled to the outer layers. FIG. 9 shows a baffle 330 capable of withstanding relatively high stresses without significant deformation. The baffle 330 allows some relative movement between the layers 332, 334 for a highly flexible multilayer material 336. For example, the baffle 330 can withstand high compressive forces without collapsing. The illustrated baffle 330 includes flanges 337, 339 coupled to the upper layer 332 and flanges 340, 342 coupled to the lower layer 334 for inhibiting peeling.

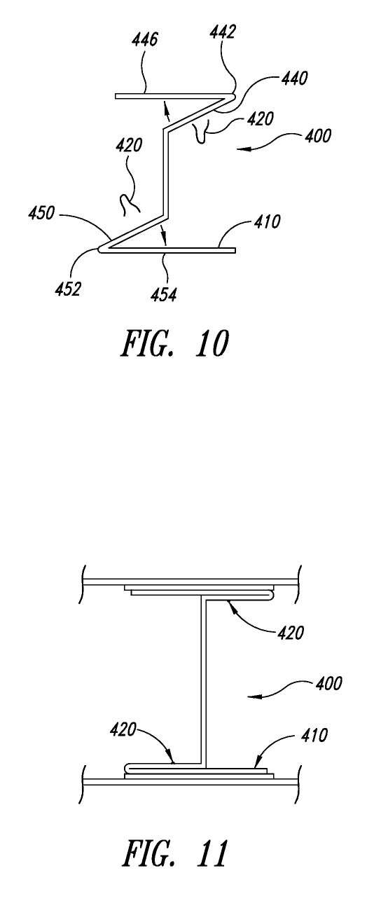

FIGS. 10 and 11 show a baffle assembly 400 including a baffle 410 and a plurality of couplers 420 (illustrated as stitches). FIG. 10 illustrates the couplers 420 separated from the baffle 410, which is manufactured from a sheet of material capable of being folded upon itself. The installed couplers 420 of FIG. 11 keep the baffle 410 in a desired configuration. In some embodiments, the couplers 420 includes, without limitation, one or more stitches, fasteners (e.g., mechanical fasteners, staples, etc.), welding, adhesives, and the like. Such couplers allow for quick and convenient assembly and installation of the baffle 410.

To install the baffle assembly 400, an upper arm 440 of FIG. 10 can be rotated about a hinge or fold line 442 towards the upper portion 446. Similarly, a lower arm 450 can be rotated about a hinge or fold line 452 towards the lower portion 454. The coupler 420 can then couple the upper arm 440 to the adjacent upper portion 446, and another coupler 420 can couple the lower arm 450 to the lower portion 454. The baffle 410 can then be installed between and coupled to the first and second layers 120, 122.

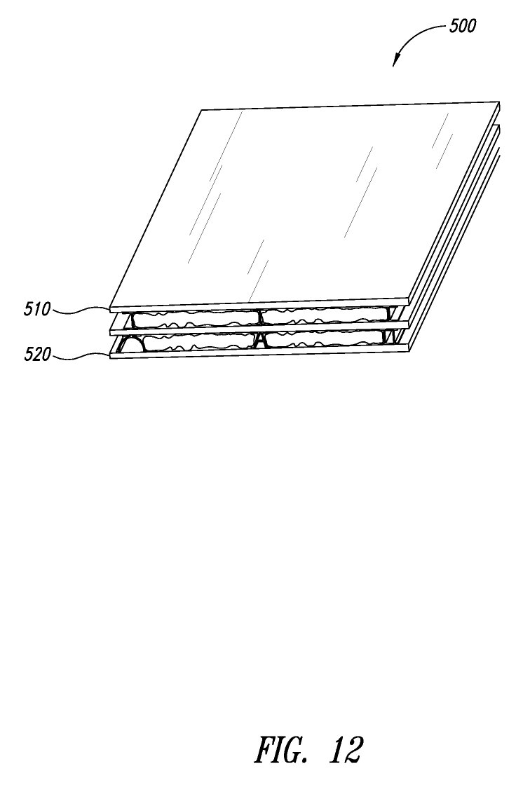

Referring to FIG. 12, a stack 500 includes a plurality of multilayer materials 510, 520. Any number of multilayer materials can be coupled together to form a stack of a desired size. Each layer 510, 520 can function as an insulator. Different types of baffles can be positioned at various locations in the stack 500 to achieve the desired mechanical characteristics, such as drapability, strength, durability, and the like.

FIG. 13 shows a multilayer material 600 that includes a baffle 610 with a web 632 formed by overlapping central web portions 613, 615. The inwardly extending web portion 613 is physically coupled to the inwardly extending member 615 via stitching 620. Each of the web portions 613, 615 can be a tether, elongated strip (e.g., a strip of fabric, a polymer strip, etc.), or other type of flexible one-piece or multi-piece component. An upper flange 619 connects the web portion 613 to a first layer 602. A lower flange 621 connects the web portion 615 to a second layer 604. The upper and lower flanges 619, 621 can be in a strip (e.g., an elongate strip of fabric, tape, and the like), a circular or elliptical anchor, or the like.

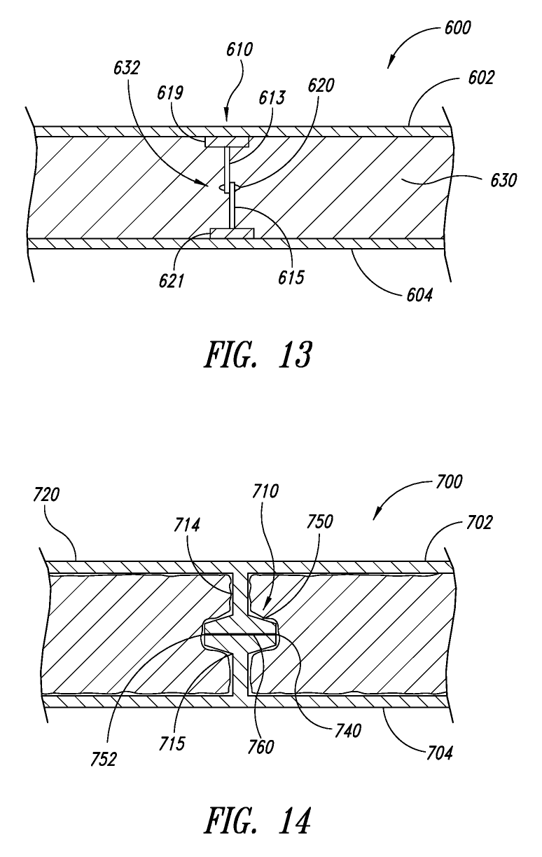

FIG. 14 shows a multi-piece baffle 710 that includes an inwardly extending first web portion 714 and an inwardly extending second web portion 715 coupled to the first web portion 714. The first and second web portions 714, 715 can be integrally formed with the layers 702, 704. By way of example, the first layer 702 can be formed by a thermoforming process so as to monolithically form the first web portion 714 and the outer layer 702. Alternatively, the first and second web portions 714, 715 can be separate components that are coupled to the layers 702, 704, respectively, using flanges.

The first and second web portions 714, 715 meet at a central region of the material 700 (e.g., generally midway between the first layer 702 and the second layer 704). Each of the web portions 714, 715 has a generally T-shaped cross-section. An illustrated interface 740 is formed by a horizontal flange 750 that mates with a complementary horizontal flange 752. The interface 740 is formed by an adhesive 760. The flanges 750, 752 are configured to distribute tensile loads along the interface 740 to reduce, limit, or substantially prevent peeling. Additionally or alternatively, stitching or other fasteners can couple the flanges 750, 752 together, if needed or desired.

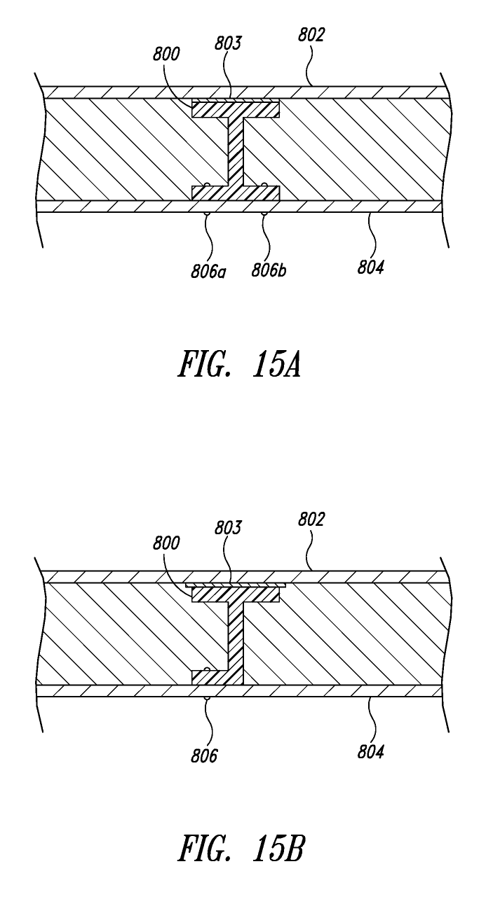

Different coupling techniques can be used to couple different sides of baffles to spaced apart layers. FIG. 15A shows an I-shaped baffle 800 stitchlessly coupled to a first layer 802 by an adhesive 803 and coupled to a second layer 804 by stitching 806a, 806b (collectively 806). FIG. 15B shows a J-shaped baffle 800 having a free end 807 coupled to the layer 804 via stitching 806.

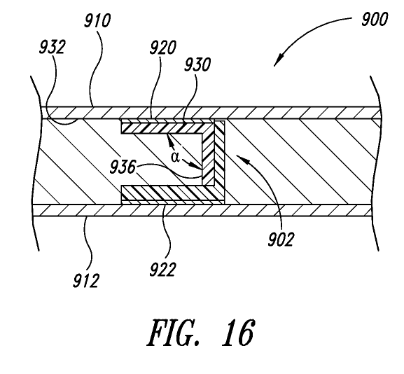

FIG. 16 shows a baffle assembly 902 between an upper layer 910 and a lower layer 912. The baffle assembly 902 includes an upper baffle portion 920 that is nested with and coupled to a lower baffle portion 922. The baffle portions 920, 922 can be generally similar to each other and, accordingly, the following description of one of the baffle portions applies equally to the other.

The baffle portion 920 has a generally L-shaped transverse cross-section and includes a mounting flange 930 for coupling to a lower surface 932 of the upper layer 910 and a web portion 936 for coupling to the lower baffle portion 922. The mounting flange 930 overlays a portion of the upper layer 910. The web portion 936 extends generally perpendicularly away from the upper layer 910. In some embodiments, an angle a defined between the mounting flange 930 and the web portion 936 is in a range of about 70 degrees to about 110 degrees.

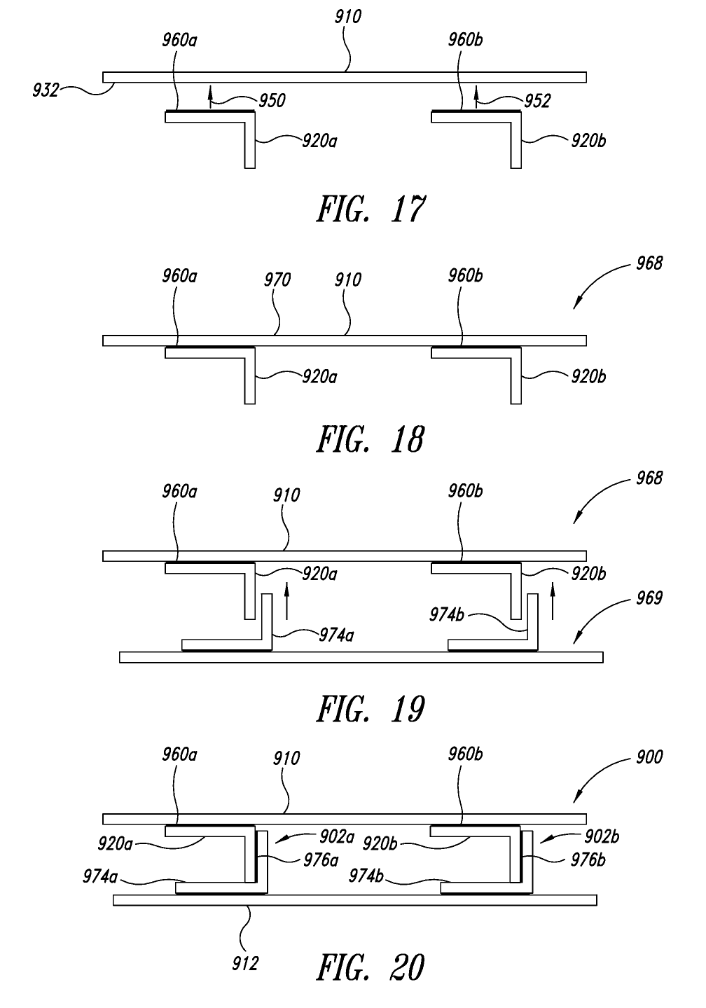

FIGS. 17 to 20 illustrate one method of manufacturing the multilayer material 900. Generally, first baffles are stitchlessly coupled to a lower surface of a first textile layer such that each of the first baffles has a first web portion extending away from the lower surface. Second baffles are coupled to an upper surface of a second textile layer such that each of the second baffles has a corresponding second web portion extending away from the upper surface. The first and second baffles are then coupled together. For example, the first web portions can be coupled to corresponding second web portions such that the first textile layer is fixedly coupled to the second textile layer. Supporting films can be incorporated into the process, if needed or desired.

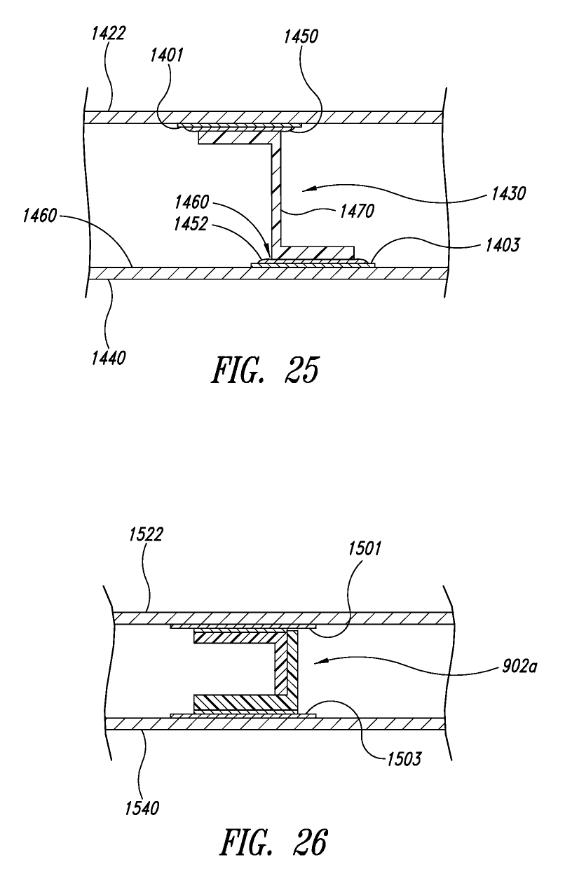

FIG. 17 shows baffle portions 920a, 920b (collectively 920) spaced apart from the upper layer 910. The baffle portions 920 can be moved towards the upper layer 910, as indicated by arrows 950, 952, such that layers of adhesive 960a, 960b (collectively 960) physically contact the lower surface 932. Although not illustrated, different types of supporting films can be positioned along the lower surface 932, as discussed in connection with FIGS. 25 and 26.

FIG. 18 shows an upper sheet assembly 968 that includes baffle portions 920 coupled to the upper layer 910 via adhesive 960. Advantageously, an upper surface 970 of the upper layer 910 is an uninterrupted smooth surface, thus alleviating problems associated with protruding features, such as stitching, which can be prone to snagging, tears, and the like, and holes. The upper sheet assembly 968 can be rolled up, folded, or stacked for convenient transport. The rolled up sheet 968 can then be unfurled to couple it to another sheet assembly, as discussed below.

FIG. 19 shows the upper sheet assembly 968 assembled with a lower sheet assembly 969. The baffle portions 920a, 920b mate with complementary baffle portions 974a, 974b (collectively 974) such that the assembled baffle assemblies 902a, 902b can have substantially I-shaped transverse cross-sectional profiles, substantially H-shaped transverse cross-sectional profiles, substantially Z-shaped cross-sectional profiles, or substantially C-shaped cross-sectional profiles. Other cross-sectional profiles are also possible.

After positioning the baffle portions 920 adjacent to the corresponding baffle portions 974, the baffle portions 920, 974 are fixedly coupled together. In the illustrated embodiment, adhesives 976a, 976b couple the baffle portions 920 to the baffle portions 974. The first textile layer 910 can be substantially parallel to the second textile layer 912 such that the material 910 has a substantially uniform thickness T, as shown in FIG. 20. in some embodiments, the baffle portions 920 are simultaneously coupled to the corresponding baffle portions 974. In some embodiments, the baffle portions 920 are successively coupled to the corresponding baffle portions 974. Insulation can be installed before, during, and/or after coupling the baffle portions 920 to the baffle portions 970. The assembled material 900 can conveniently cut into various shapes to form different articles.

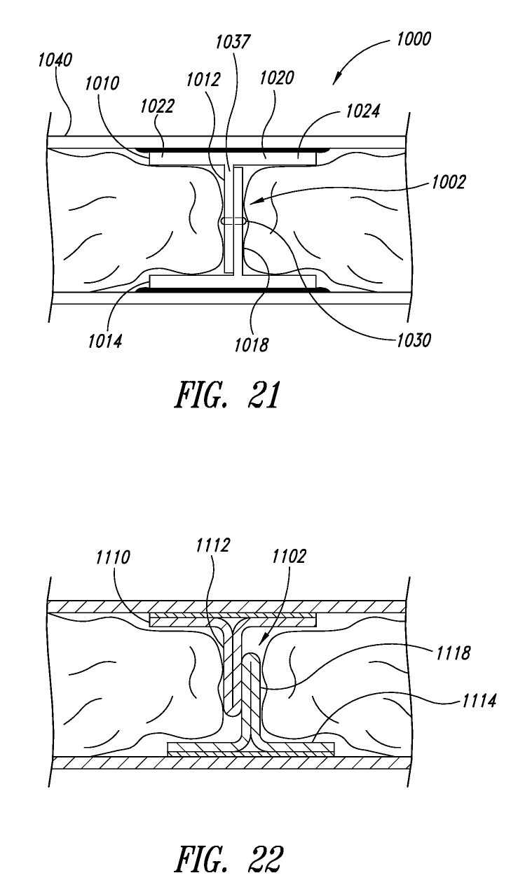

Referring to FIG. 21, material 1000 includes a baffle assembly 1002 that has an upper baffle portion 1010 having a downwardly extending web portion 1012 and a lower baffle portion 1014 having an upwardly extending web portion 1018. The web portions 1012, 1018 are generally straight and form a lap joint. The upper baffle portion 1010 includes a mounting member 1020 defining a pair of flanges 1022, 1024 extending outwardly from an upper end 1037 of the web portion 1012.

The illustrated baffle assembly 1002 has a generally I-shaped cross-section. Each of the baffle portions 1010, 1014 has a generally T-shaped cross-section. In some embodiments, the web portions 1012, 1018 are I-shaped, L-shaped, or the like.

FIG. 22 shows a baffle assembly 1102 that includes an upper baffle portion 1110, illustrated as a T-shaped member, having a downwardly extending web portion 1112 made of a folded section of material. The baffle assembly 1102 also includes a lower baffle portion 1114 having an upwardly extending web portion 1118 made of a folded section of material. The overlapping web portions 1112, 1118 can be coupled together via one or more stitches, adhesives, and the like. Each of the baffle portions 1110, 1114 can be formed of a flexible material, such as a layer of fabric, that is folded upon itself to form the web portions 1112, 1118, respectively. In this manner, two pieces of material can be used to form the substantially “I” shaped baffle assembly 1102.

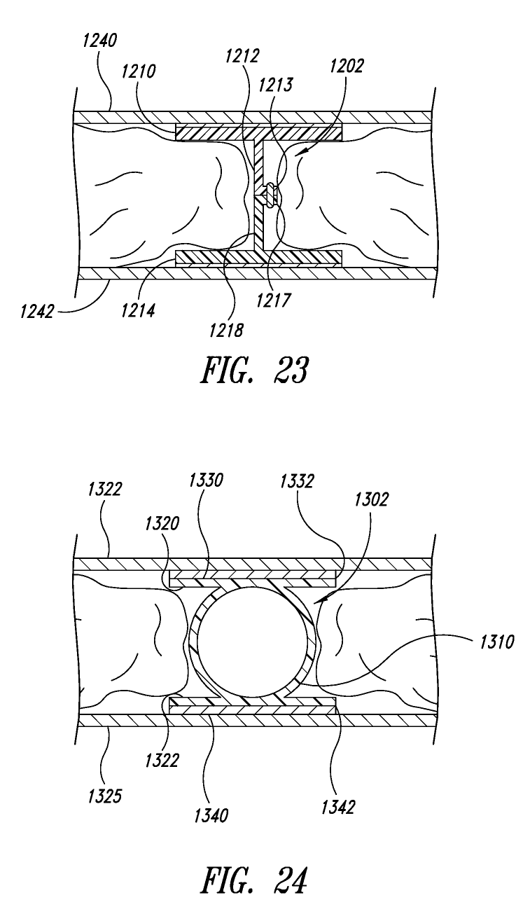

Referring to FIG. 23, a baffle assembly 1202 includes an upper baffle portion 1210 having a downwardly extending web portion 1212 having a free end coupled to a free end of a lower web portion 1218 of a lower baffle portion 1214. The free ends 1213, 1217 can be coupled together using one or more stitches, as illustrated, and/or adhesives. The interface between the free ends 1213, 1217 can be generally midway between outer layers 1240, 1242. The illustrated web portions 1212, 1218 have a J-shaped configuration.

To assemble the baffle assembly 1202, the layer 1240 carrying the baffle portion 1210 can be positioned with respect to the layer 1242 carrying the lower baffle portion 1214. The free end 1213 is mated with the free end 1217.

After bringing the free ends 1213, 1217 together, they can be conveniently coupled together.

FIG. 24 shows a baffle assembly 1302 that includes an upper member 1320 coupled to a layer 1322, a lower member 1322 coupled to a layer 1325, and a tubular central web 1310 interposed and connected to the upper and lower members 1320, 1322. The illustrated upper member 1320 includes a pair of flanges 1330, 1332 extending outwardly from an upper end of the central web 1310. The lower member 1322 includes a pair of flanges 1340, 1342 extending outwardly from a lower end of the central web 1310. To prevent separation of the center web 1310 and the upper and lower members 1320, 1322, the baffle assembly 1302 can be monolithically formed of a knitted fabric or material. Such a one-piece construction allows significant tensile or compressive forces to be applied to the baffle assembly 1302. In other embodiments, the baffle assembly 1302 has a multi-piece construction. For example, an upper member 1320 can be coupled to the separate central web 1310. The lower member 1322 can be a separate component coupled to the central web 1310.

Various types of supporting films can be incorporated into the constructions disclosed herein. Supporting films can be made of a relatively tough material that is capable of distributing different types of loads to an adjacent component. For example, the adhesive layers discussed in connection with FIGS. 1-22 can be replaced with a supporting film for coupling to a layer of the fabric and an adhesive layer for coupling a baffle to the fabric.

FIG. 25 illustrates a supporting film 1401 between a first layer 1422 and a baffle 1430. A supporting film 1403 is positioned between a lower layer 1440 and the baffle 1430. Adhesive 1450 couples the baffle 1430 to the supporting film 1401. Adhesive 1452 couples the baffle 1430 to the supporting film 1403. The supporting films 1401, 1403 extend outwardly past the baffle 1430.

At 1460, the baffle 1430 is bonded to the supporting film 1403 with the adhesive 1452 that provides a relatively high peel resistance so as to transfer loads to the supporting film 1403. For example, if the web 1470 is pulled away from the layer 1440, the tensile load is transferred via the adhesive 1452 to the supporting film 1403. Even if the lower layer 1440 is a textile providing a relatively poor bond strength (e.g., the layer 1440 has a coating or layer unsuitable for bonding), the supporting film 1403 can be sufficiently large to provide a sufficient bond to limit, minimize, or substantially prevent peeling between these components. The contact surface area of the film 1407 can be increased to decrease the stress in the bond. The number, strength, and type of supporting films can be selected based on the characteristics of layer 1440 and forces experienced during use. The layer 1440 can be a laminated or coated textile that provides a relatively high or low bond strength. The supporting film 1403 can be adhered to the layer 1440 using various types of adhesives, as well as stitching. For example, the illustrated supporting film 1403 can be self-adhered or glue-adhered to an inner surface 1460 of the layer 1440.

The supporting films can have a surface area that is larger (e.g., 24% larger, 50% larger, 100% larger) than the coupling surface of the baffle. The baffle assembly 902a of FIG. 20 can be utilized with supporting films 1501, 1503. Other areas are also possible. FIG. 26 shows a pair of supporting films 1501, 1503 coupled to layers 1522, 1540. The baffle assembly 902a is between the films 1501, 1503.

Various methods and techniques described above provide a number of ways to carry out the invention. The skilled artisan will recognize the interchangeability of various features from different embodiments disclosed herein. Similarly, the various features and acts discussed above, as well as other known equivalents for each such feature or act, can be mixed and matched by one of ordinary skill in this art to perform methods in accordance with principles described herein. Additionally, the methods which are described and illustrated herein are not limited to the exact sequence of acts described, nor are they necessarily limited to the practice of all of the acts set forth. Other sequences of events or acts, or less than all of the events, or simultaneous occurrence of the events, may be utilized in practicing the embodiments of the invention.

The embodiments, features, systems, devices, materials, methods and techniques described herein may, in some embodiments, be similar to any one or more of the embodiments, features, systems, devices, materials (including fabrics, repellants, polymers, and the like), methods and techniques described in U.S. Pat. No. 6,797,352 and U.S. Provisional Patent Application No. 60/961,151. In addition, the embodiments, features, systems, devices, materials, methods and techniques described herein may, in certain embodiments, be applied to or used in connection with any one or more of the embodiments, features, systems, devices, materials, methods and techniques disclosed in the above-mentioned U.S. Pat. No. 6,797,352 and U.S. Provisional Patent Application No. 60/961,151.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof.
What is claimed is:

1. A multilayer fabric sheet, comprising.
a first layer of fabric;
a second layer of fabric;
insulation positioned between the first layer of fabric and the second layer of fabric; and
a plurality of baffles between the first layer of fabric and the second layer of fabric, each baffle including an upper member lying along and stitchlessly coupled to the first layer of fabric, a lower member lying along and coupled to the second layer of fabric, and a central member having an upper end physically coupled to the upper member and a lower end physically coupled to the lower member, the upper end spaced apart from opposing terminal edges of the upper member, the lower end spaced apart from opposing terminal edges of the lower member.

2. The sheet of claim 1, further comprising a supporting film between the baffle and the upper first layer of fabric, the supporting film extending outwardly past the baffle along the first layer of fabric.

3. The sheet of claim 1, wherein a peel resistance at an interface between at least one of the baffles and the first layer of fabric is equal to or greater than 10 lbf/inch, as measured according to ASTM D-751-98.

4. The sheet of claim 1, wherein the baffle extends continuously between an upper surface of the upper member to a lower surface of the lower member.

5. The sheet of claim 1, further comprising:
an insulation chamber between the first layer and the second layer, at least one of the baffles defining a sidewall of the insulation chamber in which at least a portion of the insulation is disposed.

6. The sheet of claim 1, wherein at least one of the baffles and both the first layer and the second layer cooperate to prevent a significant amount of the insulation from traveling between a pair of compartments on either side of the at least one baffle.

7. The sheet of claim 1, wherein at least one of the baffles has a height defined between an outer surface of the upper member and an outer surface of the lower member, the height in a range of about ¼ inch to about 1 inch.

8. The sheet of claim 1, wherein at least one of the baffles has a substantially I-shaped transverse cross-section.

9. The sheet of claim 1, wherein at least one of the baffles is moveable between a substantially I-shaped configuration and a substantially planar configuration.

10. The sheet of claim 1, wherein the central member is substantially perpendicular to both the upper member and the lower member.

11. The sheet of claim 1, wherein the upper member is adhered to the first layer and the lower member is adhered to the second layer.

12. The sheet of claim 1, wherein at least one of the baffles comprises a material that is more rigid than the insulation.

13. The sheet of claim 1, wherein a plurality of sections of the first layer and the second layer adjacent the plurality of baffles are devoid of needle holes.

14. An article of clothing comprised mostly of the multilayer fabric sheet of claim 1.

15. A multilayer material for use in fabrication an article of clothing, the multilayer material comprising:
a first layer of fabric;
a second layer of fabric;
an insulating material between the first layer and the second layer; and
a plurality of elongate baffles stitchlessly coupled to the first layer of fabric and coupled to the second layer of fabric, each of the baffles having a pair of outwardly extending flanges coupled to the first layer of fabric.

16. The material of claim 15, further comprising a supporting layer between at least one of the baffles and the upper first layer of fabric, the at least one of the baffles coupled to a central region of the supporting layer.

17. The material of claim 15, wherein the pair of outwardly extending flanges is adhered to and lays flat against an interior surface of the first layer of fabric facing the insulating material.

18. The material of claim 15, wherein each baffle includes another pair of outwardly extending flanges coupled to the second layer of fabric.

19. The material of claim 15, wherein the plurality of baffles is stitchlessly coupled to the second layer of fabric.

20. The material of claim 15, wherein each of the baffles is coupled to the second layer of fabric by at least one stitch.

21. The material of claim 15, wherein the first layer of fabric is an outer shell for a jacket and the second layer of fabric is a lining for the jacket.

22. A method of manufacturing, comprising:
stitchlessly coupling an upper member of an internal baffle to an upper layer of fabric, the internal baffle including a lower member and a central member having an upper end coupled to the upper member and a lower end coupled to the lower member, the upper end spaced apart from opposing free ends of the upper member, the lower end spaced apart from opposing free ends of the lower member;
coupling the lower member to a lower layer of fabric; and
positioning insulation between the upper layer of fabric and the lower layer of fabric.

23. The method of claim 22, further comprising coupling a supporting film between the baffle and the upper layer of fabric, the supporting film extending outwardly past the baffle along the upper layer of fabric.

24. The method of claim 22, wherein stitchlessly coupling the upper member to the upper layer of fabric includes adhering the upper member to the upper layer of fabric.

25. The method of claim 22, wherein stitchlessly coupling the upper member to the upper layer of fabric includes permanently coupling the upper member to the upper layer of fabric such that the internal baffle is moveable between a substantially I-shaped configuration and a substantially planar configuration.

26. The method of claim 22, wherein stitchlessly coupling the upper member to the upper layer of fabric includes positioning an adhesive between the upper member and the upper layer of fabric.

27. The method of claim 26, wherein the adhesive is a material selected from a group consisting of polyurethane, polyester, and polyamide.

28. A method of manufacturing a multilayer material for producing an article of clothing, method comprising:
providing a first layer of fabric and a second layer of fabric;
stitchlessly coupling a plurality of longitudinally-extending baffles to the first layer of fabric such that each of the baffles has an outwardly extending flange lying along and coupled to the first layer of fabric;
coupling the plurality of baffles to the second layer of fabric; and
positioning insulation between the first layer of fabric and the second layer of fabric.

29. The method of claim 28, wherein stitchlessly coupling the plurality of baffles includes adhering the outwardly extending flanges to an interior surface of the first layer of fabric facing the second layer of fabric.

30. The method of claim 28, wherein coupling the plurality of baffles to the second layer of fabric includes stitchlessly coupling the plurality of baffles to the second layer of fabric.

31. The method of claim 28, further comprising coupling a supporting film between one of the baffles and the first layer of fabric, the supporting film extending outwardly past the baffle along the upper layer of fabric.

32. A method of manufacturing a multilayer material, comprising:
stitchlessly coupling a plurality of first baffles to a lower surface of a first textile layer such that each of the first baffles has a first web portion extending away from the lower surface;
coupling a plurality of second baffles to an upper surface of a second textile layer such that each of the second baffles has a second web portion extending away from the upper surface; and
coupling the first web portions to corresponding second web portions such that the first textile layer is coupled to the second textile layer.

33. The method of claim 32, wherein stitchlessly coupling the plurality of first baffles to the lower surface includes adhering a flange of a respective one of the first baffles to the lower surface.

34. The method of claim 32, wherein coupling the first web portions to corresponding second web portions includes successively coupling the first web portions to the corresponding second web portions.

35. The method of claim 32, wherein coupling the first web portions to corresponding second web portions includes concurrently coupling the first web portions to the corresponding second web portions.

36. The method of claim 32, further comprising positioning the first textile layer with respect to the second textile layer such that the first textile layer is substantially parallel to the second textile layer while coupling the first web portions to the second web portions.

37. The method of claim 32, further comprising positioning the first baffles relative to the second baffles to form a plurality of baffle assemblies each having a substantially I-shaped transverse cross-sectional profile, a substantially H-shaped transverse cross-sectional profile, or a substantially C-shaped cross-sectional profile.
